(19) United States
(12) Patent Application Publication
(10) Pub. No.: US 2012/0239543 A1
(43) Pub. Date: Sep. 20, 2012

(54) Payment System and Method Using Commodity-Based Electronically Traded Funds

(75) Inventor: Gregory Paul Ryan, Hillsborough, CA (US)

(73) Assignee: DARIC, INC., Hillsborough, CA (US)

(21) Appl. No.: 13/424,042

(22) Filed: Mar. 19, 2012

Related U.S. Application Data
(60) Provisional application No. 61/454,451, filed on Mar. 18, 2011.
(60) Provisional application No. 61/454,463, filed on Mar. 18, 2011.
(60) Provisional application No. 61/454,467, filed on Mar. 18, 2011.

(51) Int. Cl. G06Q 40/04

(52) U.S. Cl. 705/37

(57) ABSTRACT

A system and a method are disclosed for using a commodity-based exchange traded fund (ETF) to implement an electronic payment currency. The commodity-based ETF provides an inflation mirror using a basket of tradable commodities such as metals, energy, agricultural products, etc. Shares of the commodity-based ETF function as an electronic currency unit for use in transactions. A user may direct the system to transfer shares of the commodity-based ETF to a merchant in exchange for non-currency consideration such as goods and services.

### CROSS REFERENCE TO RELATED APPLICATIONS

This application claims the benefit of U.S. Provisional Applications No. 61/454,451, filed Mar. 18, 2011, No. 61/454,463, filed Mar. 18, 2011, and No. 61/454,467, filed Mar. 18, 2011, each of which is incorporated by reference in its entirety.

### FIELD OF ART

The disclosure generally relates to the field of electronic payment systems and electronic payment currencies.

### BACKGROUND

Currencies historically have been backed by physical substances having intrinsic value. The physical substances may be gold, silver, copper, shells, etc. Currency could be exchanged for these physical substances. By contrast, current nation state issued fiat currencies have value based solely on faith in governments issuing the money. The fiat currencies have no intrinsic value and are not fixed in value compared to any objective standard. A citizen of a nation state cannot give the government fiat currency and ask for gold or silver in exchange. Since nation state currencies require no backing, it is incredibly tempting for governments to simply issue additional currency, particularly in times of duress. Issuance of additional currency by a particular nation state devalues existing currency (inflation), and individuals holding the currency are forced to look for alternative places to hold their wealth, lest they lose their purchasing power. Some individuals may look toward preserving wealth in currencies of other nation states. However, all nation states currently use fiat money and users of the fiat money are subject to the same mismanagement, political, and inflation risks. Preserving wealth in other currencies also introduces foreign exchange overhead and currency exchange risk. Hedging against exchange rate fluctuations introduces additional overhead.

Some individuals have invested in physical assets such as gold or real-estate. Maintaining wealth in physical assets such as gold or real-estate may reduce inflation risk, but physical assets are difficult to transfer, may be illiquid, and are impractical for use in business transactions.

### BRIEF DESCRIPTION OF DRAWINGS

The disclosed embodiments have other advantages and features which will be more readily apparent from the detailed description, the appended claims, and the accompanying figures (or drawings). A brief introduction of the figures is below.

FIG. 1 illustrates a particular example of a system for implementing an electronic payment currency.

FIG. 2 illustrates a particular example of a system for conducting a transaction using an electronic payment currency.

FIG. 3 illustrates a particular example of a commodities exchange traded fund (ETF) backed payment currency.

FIG. 4 illustrates a particular example of a technique for implementing an electronic payment currency.

FIG. 5 illustrates a particular example of a technique for conducting a transaction.

FIG. 6 illustrates a particular example of the use of an electronic payment currency in e-commerce.

FIG. 7 illustrates a particular example of a payment processing system.

### DETAILED DESCRIPTION

Techniques and mechanisms are provided for improving upon existing fiat currency systems.

The Figures and the following description relate to preferred embodiments by way of illustration only. It should be noted that from the following discussion, alternative embodiments of the structures and methods disclosed herein will be readily recognized as viable alternatives that may be employed without departing from the principles of what is claimed.

The techniques and mechanisms of the present invention provide for an electronic currency that preserves wealth against political risks, foreign exchange risks, inflation risks, etc. According to various embodiments, the electronic currency is provided as shares of a commodity-based exchange traded fund (ETF). The commodity-based ETF reflects the inherent value of assets such as metals, agricultural products, energy resources, etc. In particular embodiments, the commodity-based ETF tracks inflation and provides investors with units or shares that can be used to make domestic and international purchase transactions. According to various embodiments, units or shares of a commodity-based ETF can be used in lieu of nation state based currencies to make transactions. Debit cards and checks can draw from a commodity-based ETF account. Payments of units or shares can be made from one account holder directly to another account holder for goods and services without exchanging any currencies or making any foreign exchange transactions.

Commodity-based ETFs generally use commodity futures, over-the-counter forward contracts, or stocks of companies that derive their income from commodities as an underlying asset. According to various embodiments, a commodity-based ETF includes investments in the following: precious metals (e.g., gold, silver, platinum), energy (e.g., heating oil, crude, natural gas), agriculture (e.g., wheat, corn, soybeans, live cattle, lean hogs, cotton, coffee, cocoa, sugar, orange juice) and base metals (e.g., copper, aluminum, zinc). In particular embodiments, a commodity-based ETF provides a low cost, highly liquid investment avenue for risk-averse investors, who are primarily concerned about preserving the value of their money. The portfolio is constructed in such a way that it keeps the pace with inflation or slightly outperforms inflation.

A slightly heavier weighting in precious metals and a smaller weighting in the more volatile energy and grain sectors more accurately responds to the fluctuations in the U.S. Dollar and inflation concerns. The more stable prices of meats and softs reduce the volatility of the index as a whole and counter the fluctuations in the other sectors. Overall, the portfolio is balanced with a well-diversified set of inflation hedges.

Users can make payments through cell phones, personal computers, mobile devices, debit cards, checks, terminals, passphrases, or other identifiers that can securely authenticate a user. Users including merchants can also receive payments using the same mechanisms.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### Configuration Overview

One embodiment of a disclosed system, method and computer readable storage medium that includes a method, comprising receiving a request from a computing device associated with a user to make a payment to a merchant account, the payment comprising a first quantity denominated in a fiat currency. Authenticating the user and transferring a second quantity of shares of an ETF to the merchant account from a user account associated with the user. The ETF is a commodity-based fund comprising shares of component commodities and the second quantity of shares is determined based on the first quantity denominated in the fiat currency. The method confirms to a merchant associated with the merchant account that the transfer of the second quantity of shares of the ETF has been made to the merchant account from the user account and a notification is received of a transfer of a non-monetary interest from the merchant to the user.

### Description of Embodiments

The techniques and mechanisms of the present invention will be described in the context of commodities ETF-backed payment currencies. However, it should be noted that the techniques and mechanisms of the present invention apply to a variety of different data constructs including variations to data blocks. In the following description, numerous specific details are set forth in order to provide a thorough understanding of the present invention. Particular example embodiments of the present invention may be implemented without some or all of these specific details. In other instances, well known process operations have not been described in detail in order not to unnecessarily obscure the present invention.

Techniques and mechanisms are provided for using a payment currency such as a commodity-based ETF payment currency. Units of a commodity-based ETF may correspond to shares or partial shares of a basket of tradable commodities such as metals, energy, agricultural products, and/or other assets. The commodity-based ETF provides an inflation mirror. Units or shares of the commodity-based ETF can function as an alternative electronic currency for use in domestic and international transactions. The alternative electronic currency reduces foreign exchange overhead and reduces inflation, political, and mismanagement risk inherent in fiat currencies. A user or merchant having a commodity ETF interface can receive payment for goods/services through the commodity ETF interface. Users transfer shares of the commodity-based ETF to the merchant using a merchant commodity ETF interface that may include modalities such as near field communication receivers, card readers, computer systems, terminals, radio frequency identification readers, etc. Units or shares of the commodity-based ETF can function as an alternative payment currency for use in domestic and international transactions. A commodity-based ETF transfer system is associated with an account database. A commodity-based ETF share transfer mechanism may transfer shares from a user account to a target account in exchange for non-currency consideration. Thus users may pay for goods and services without the transfer of fiat currency payments.

### Embodiment of a System for Implementing Electronic Payment Currency

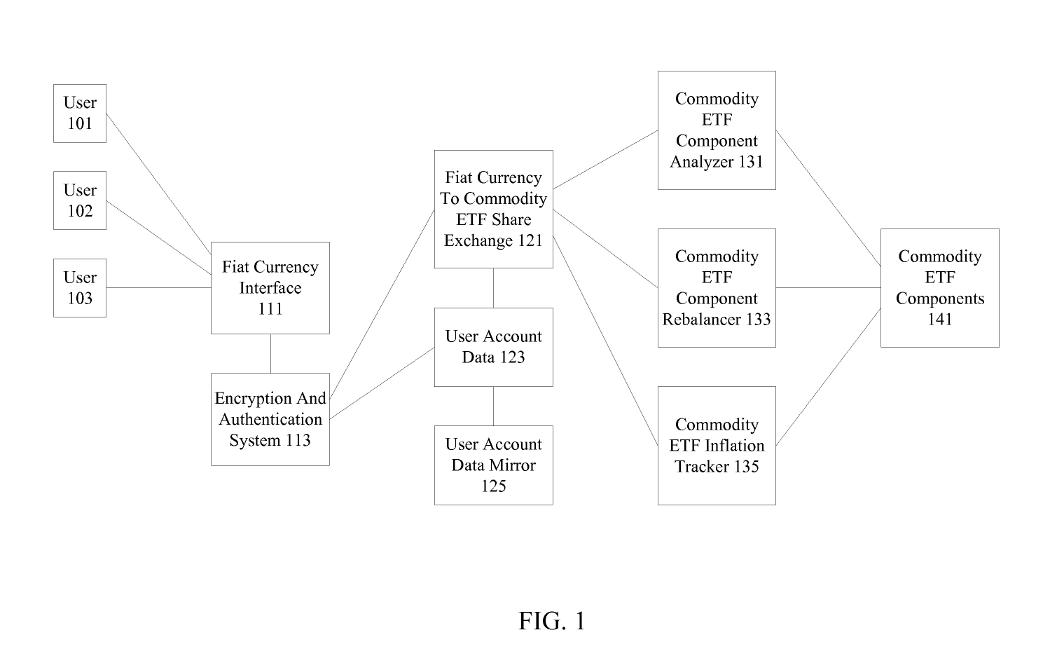

FIG. 1 illustrates one example of a system for implementing a commodity ETF based payment currency. According to various embodiments, users 101, 102, and 103 access a fiat currency interface 111. Users 101, 102, and 103 may be using computer systems, mobile devices, debit cards, near field communication devices, biometric identifiers, etc., to access the fiat currency interface 111. According to various embodiments, the fiat currency interface is an application that allows transfer of fiat currencies such as Dollars, Yen, Euros, Krona, Francs, Won, etc., to a fiat currency to commodity ETF share exchange 121. According to various embodiments, transactions and data are encrypted and authenticated using a cryptographic encryption and authentication system 113. Cryptography may involve symmetric encryption, public-key private-key encryption, digital signatures, etc. In particular embodiments, any account access, exchange, or communication is encrypted. User account data 123 is maintained and replicated using user account data mirrors 125.

Fiat currencies are exchanged for commodity-based ETF units or shares at the exchange 121. The number of shares of the commodity-based ETF that are credited to the user account is determined based on the real value of the fiat currency or currencies exchanged. Commodity ETF components are analyzed using a commodity ETF component analyzer 131 and rebalanced using a commodity ETF component rebalancer 133 based on accumulation or withdrawal of shares. When a user exchanges a fiat currency for shares of the commodity-based ETF, the rebalancer 133 may transfer existing shares of the ETF to the user's account. However, if large numbers of shares are being purchased (by single or multiple users) there may be insufficient shares in reserve to transfer to these users. In this case the rebalancer 133 may generate additional shares of the commodity-based ETF to transfer to user accounts. In ordinary circumstances generating additional shares of the ETF to transfer to users would debase the existing ETF shares, however, debasement can be avoided by purchasing additional shares of component commodities to offset the issuance of new ETF shares. The increase in the total commodity holdings of the ETF offsets the increase in volume of ETF shares issued and prevents debasement of the existing ETF shares.

When users exchange shares of the commodity-based ETF for a fiat currency, fiat currency may be transferred to their account from the reserves of the system, and shares of the commodity-based ETF may be moved from the users' account to the system reserve. These shares may be transferred to other users in exchange for fiat currency payments to replenish the system's currency reserves. If the system has insufficient fiat currency in reserve to make a payment to a user in exchange for that user's ETF shares, the rebalancer 133 may sell shares of component commodities in the market to obtain the necessary fiat currency funds. To avoid debasing the ETF shares in this situation, a proportionate number of ETF shares may be removed from circulation to reflect the reduction in the total value of the ETF. Similarly, when a user exchanges fiat currency for shares of the commodity-based ETF, if shares are not available in reserve to transfer to the user, the rebalancer 133 may purchase commodity components of the ETF on the market using the fiat currency that has been deposited, and new shares of the ETF may be generated without debasing the value of the existing ETF shares.

A commodity ETF inflation tracker 135 gauges whether commodity ETF components 141 are accurately tracking inflation. The commodity ETF inflation tracker 135 may direct the component rebalancer 133 to sell or buy shares of various component commodities based on the requirements of inflation tracking

According to various embodiments, the commodity-based ETF includes a basket of commodities with the goal of mirroring inflation as closely as possible. When the fund reaches a critical mass, the fund may be used with a payment platform to have shares in the ETF function as an alternative electronic currency that can be used to make payments for goods and services. A transaction fee may be charged to generate a revenue stream. Users may keep their currency in the form of shares of the commodity-based ETF. An advantage of the disclosed configuration is a liquid currency processing system that also provides protection from government mismanagement of fiat currency, inflation, and political risk.

### Example Transaction Using an Electronic Payment Currency

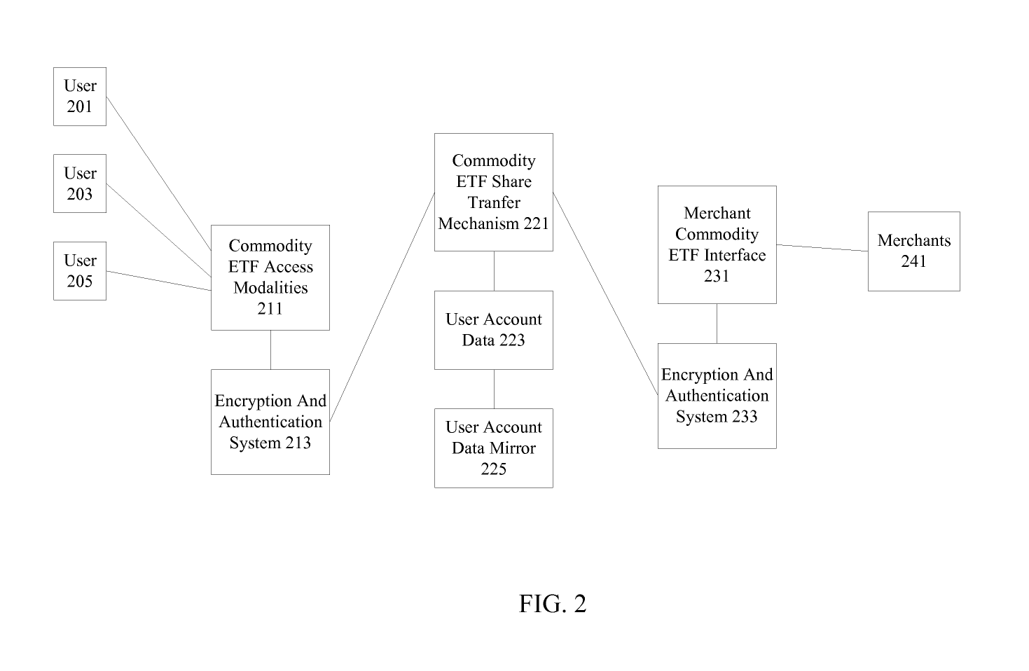

FIG. 2 illustrates one example of a payment system using a commodity-based ETF. According to various embodiments, users 201, 203, and 205 access a commodity ETF share transfer mechanism 221 through a secured system 213 using commodity ETF access modalities 211. Users may access commodity ETF assets using modalities 211 such as payment cards, mobile devices, near field communication, computer systems, biometric identifiers, passphrases, terminals, etc. In particular embodiments, a user name password identifies a user. In other examples, biometric data, a mobile device identifier, radio frequency identifier chip, custom data sequences and numbers, etc., are used to identify and/or authenticate a user. A user 201, 203, and 205 may similarly specify a target for a payment using biometric data, a mobile device identifier, radio frequency identifier chip, custom data sequences and numbers, target devices, near field communication receivers, etc., near field communication, terminals, mobile device, passphrases, merchant devices, etc.

A user 201, 203, and 205 may also specify a number of shares to transfer to a target merchant or user in exchange for goods, services, or other non-monetary interest. If the target merchant or user resides in a foreign jurisdiction with its own nation state currency, no foreign exchange or foreign exchange overhead is required. Payment is made from a user account to a target account in shares of an ETF, such as a commodity-based ETF. A commodity ETF share transfer mechanism 221 verifies the authenticity of the user and target and commits user account data 223. The user account data may also be mirrored at 225.

According to various embodiments, merchants 241 may simply be users having access to the same commodity ETF access modalities 211. Alternatively, merchants may have their own merchant commodity ETF interfaces 231 specialized for receiving commodity ETF shares. A merchant commodity ETF interface may be a terminal, a near field communication receiver, a biometric data receiver, email address, data sequence and number receiver, terminal, card reader, radio frequency identification receiver, etc. The merchant commodity ETF interface may also have its own encryption and authentication system 233.

### Example Commodity-Based ETF for Backing a Payment Currency or Payment System

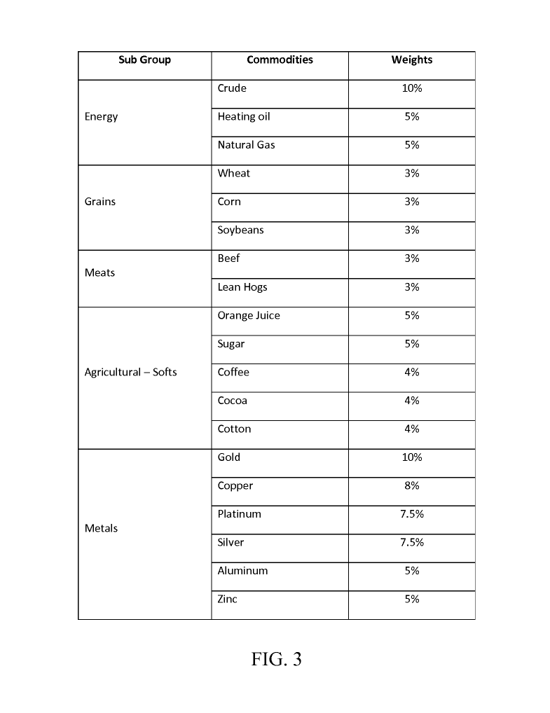

FIG. 3 illustrates one example of a commodity-based ETF that can be used to back a payment currency or electronic payment currency. According to various embodiments, a currency is based on assets having high liquidity. In particular embodiments, the currency will be based on a basket of tradable commodities. Inclusions in the basket may be precious metals (e.g., gold, silver, platinum), energy (e.g., heating oil, crude, natural gas), agriculture (e.g., wheat, corn, soybeans, live cattle, lean hogs, cotton, coffee, cocoa, sugar, orange juice), and base metals (e.g., copper, zinc, aluminum). In particular embodiments, the commodity-based ETF will use commodity futures, over-the-counter forward contracts, or stocks of companies that derive their income from commodities as an underlying asset. A slightly heavier weighting in precious metals and a smaller weighting in the more volatile energy and grain sectors more accurately responds to the fluctuations in the US dollar (USD) and inflation concerns. The more stable prices of meats and softs reduce the volatility of the index as a whole and counter the fluctuations in the other sectors. Overall, the portfolio is balanced with a well-diversified set of inflation hedges. According to various embodiments, weights among subgroups of commodities are dynamically changed and reassigned to mirror inflation. In other examples, total market index based ETF may be used as a basis for a payment currency. A variety of other indices could potentially be integrated.

### Example Method for Exchanging FIAT Currency for Electronic Payment Currency

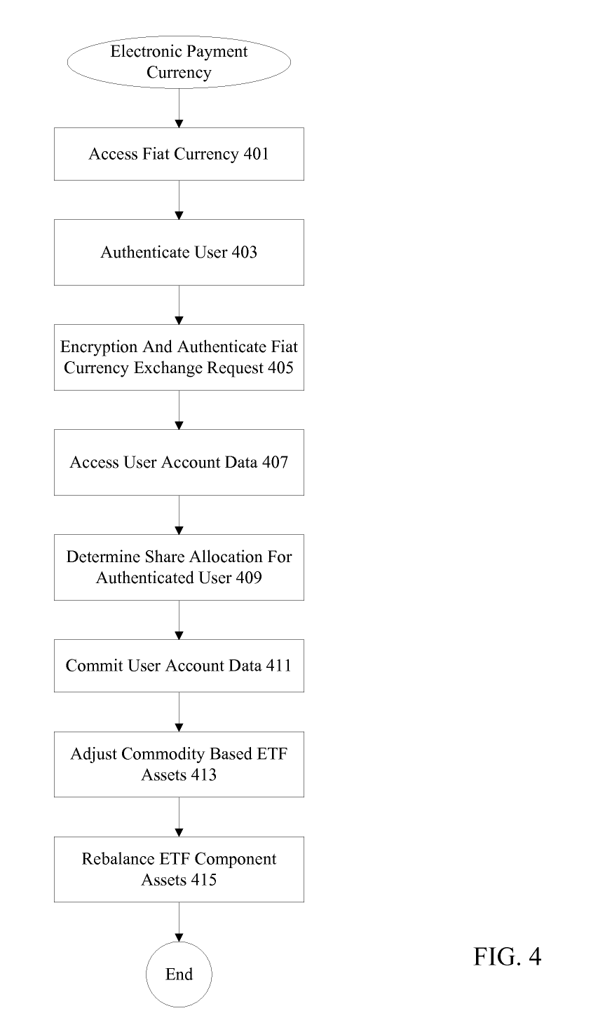

FIG. 4 illustrates one example of a technique for implementing an electronic payment currency. According to various embodiments, fiat currency is accessed at 401. Fiat currency may be accessed via electronic funds transfer, payment cards, computer systems, wire transfers, etc. A user is authenticated at 403. Authenticating a user may involve verifying a mobile device electronic serial number or other mobile identifier. Authenticating a user may also involve symmetric key or asymmetric key verification at 405. Once the user is authenticated user account data is accessed at 407. A share allocation is determined for the authenticated user at 409 based on the value of fiat currency that is transferred to the user account. User account data, including the share allocation, is committed at 411. Commodity-based ETF assets may be adjusted at 413. Reserves may be maintained to handle payouts, but if reserves are insufficient to manage a requested payout, then commodity contracts may be bought or sold based on the transaction at 413. According to various embodiments, ETF component assets may be rebalanced at 415 so that the ETF continues to track and mirror inflation. Rebalancing may itself require additional buying and/or selling of commodity contracts.

### Example Process for Implementing Electronic Payment Currency Exchange

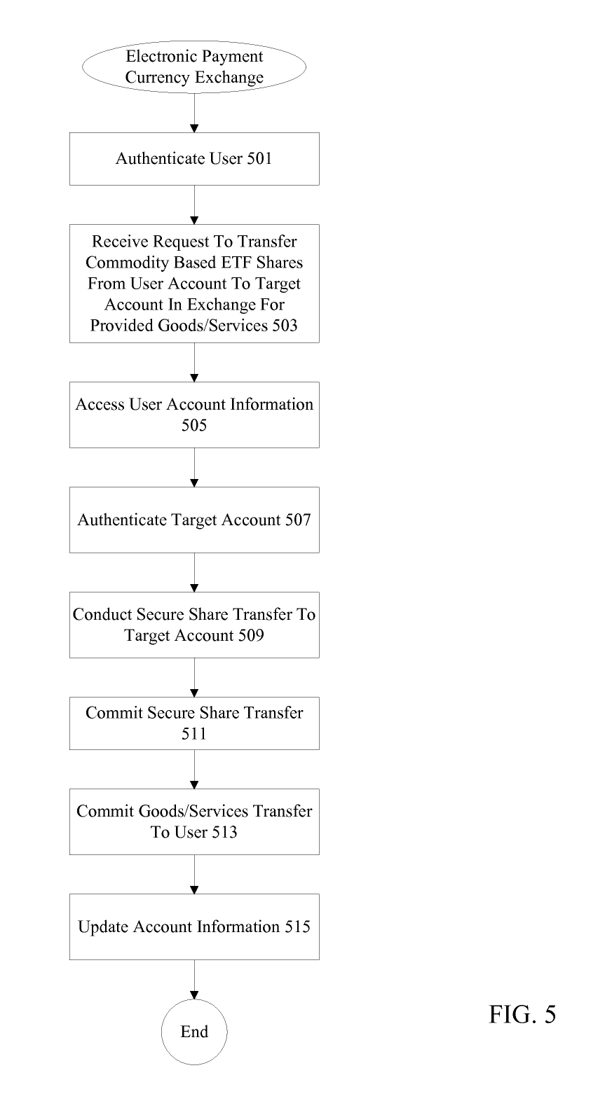

FIG. 5 illustrates one example of a technique for electronic payment currency exchange. A user is authenticated at 501. Authenticating a user may involve verifying a mobile device electronic serial number or other mobile identifier. Authenticating a user may also involve symmetric key or asymmetric key verification. A request is received to transfer commodity-based ETF shares from a user account to a target account (e.g. a merchant's account) in exchange for goods/services at 503. Notification may be sent to the system that goods/services were transferred from the merchant to the user. Account information may be accessed for a user at 505. For instance, the service may take the opportunity to verify that the user has sufficient shares of the commodity-based ETF to satisfy the transaction requested. Next, the target account may be authenticated at 507. Information for the target account may be accessed. A share transfer is made to the target account at 509 based on the transaction requested by the user. A secure share transfer is committed at 511. A goods and services transfer is committed to the user at 513. Account information is updated at 515 for both the user account and the target account. The updated account information may include the updated account balance for both the user account and the target account. Transaction records may be generated to record the transaction information.

### Example E-Commerce Transaction Using ETF-Based Electronic Payment Currency

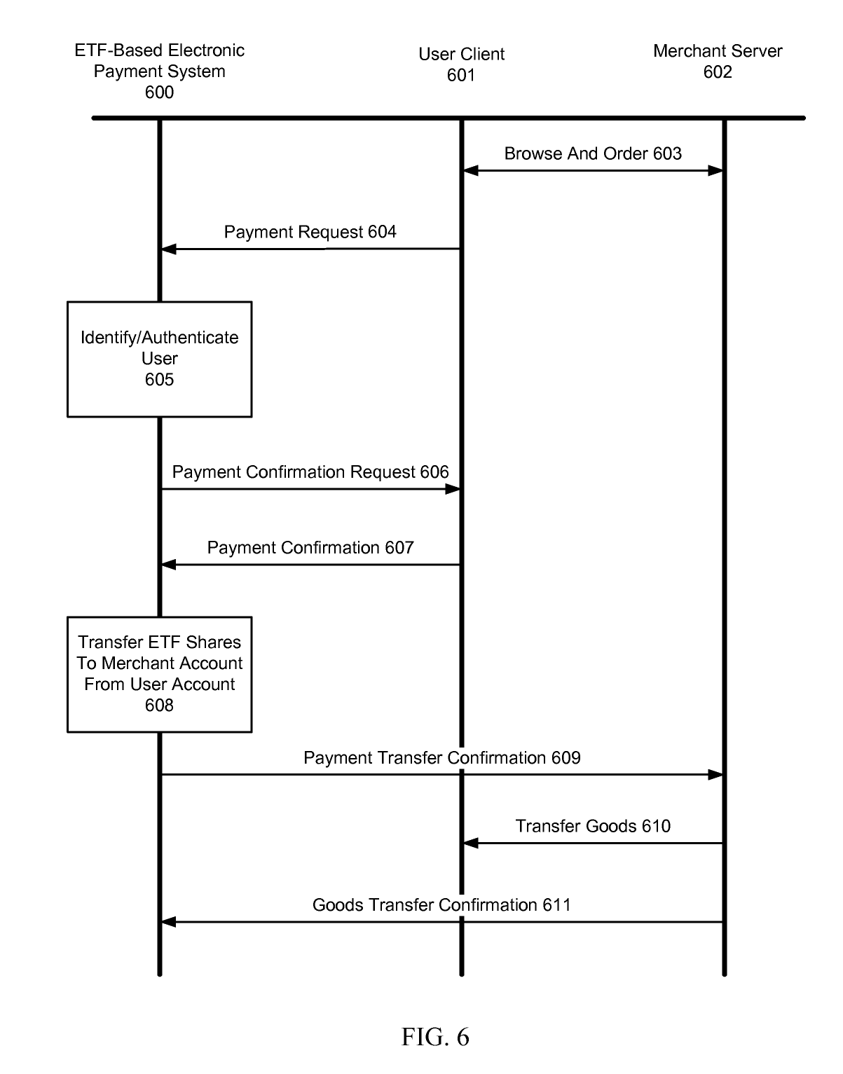

FIG. 6 illustrates one example of using an ETF-based electronic payment currency in e-commerce. In this example an ETF-based electronic payment system 600 communicates with a user client 601 and a merchant server 602 over a network such as the Internet. The ETF-based payment system 600 may include components described earlier such as the fiat currency interface 111, encryption and authentication system 113, fiat currency to commodity ETF share exchange 121, user account data 123, commodity ETF component analyzer 131, commodity ETF component rebalancer 133, commodity ETF inflation tracker 135, commodity ETF share transfer mechanism 221, merchant commodity ETF interface 231, etc. The user client 601 may be any manner of computing device capable of communicating over the network with the ETF payment system 600 and the Merchant Server 602. Examples of user clients 601 include smart phones, personal computers, tablet computers, laptop computers, etc. The merchant server 602 may be any manner of computer server operated by a merchant. Examples include web servers hosting shopping websites, service websites such as airline booking sites, auction websites such as EBAY, etc.

As a first step the user client 601 and merchant server 602 interact while the user browses and orders goods/services on the merchant website. In general the browsing and ordering 603 includes two-way communication between the user client 601 and the merchant server 602. For example, a user may request a web page containing product descriptions from the merchant server, may receive that web page, and then may make an item purchase request through the merchant's shopping interface. The user may make a purchase request, for example, by adding an item to an online shopping cart and clicking a “buy” button on the merchant's website. Once the user makes the purchase request, payment details such as price may be sent to the user client 601.

Based on the price of goods or services selected for purchase by the user, the user client 601 may send a payment request 604 to the ETF payment system 600 based on an amount requested by the merchant. The payment requested by the merchant may be denominated in a fiat currency, for example U.S. Dollars, or it may be denominated based on units of ETF-based shares. In some cases the merchant server 602 may send the payment request 604 directly to the ETF payment system, instead of the user client 601 sending the payment request.

Regardless of the source of the payment request, the ETF payment system 600 will first identify and authenticate 605 the user operating the user client 601. The identification and authentication may be done using a username/password system, a biometric ID system, or any other authentication system used in e-commerce. At this point the ETF payment system 600 may also confirm that the user has sufficient funds in their user account to meet the payment request. If the payment request was designated in a fiat currency, the ETF payment system 600 may determine the current ETF share market value in that fiat currency and use this value to determine the ETF shares necessary to make the payment. For example, if the payment requested is $100 and the market price of an ETF share is $10, then the number of ETF shares necessary to make the payment is 10.

As part of the identification/authentication process the ETF payment system 600 may send a payment confirmation request 606 to the user client 601. The payment confirmation request 606 is used to confirm that the user has authorized the payment. The payment confirmation request 606 may include a request for a user code or password to confirm the user's identity. The user confirms the payment by sending a payment confirmation 607 from the user client 601 to the ETF payment system 600. The payment confirmation 607 may include a user code or password response.

Once the confirmation is received from the user, the ETF payment system 600 transfers 608 an appropriate number of ETF shares from the user's account to the merchant's account. The number of shares transferred will depend on the payment requested. Once the transfer is completed, the ETF payment system 600 will send a payment transfer confirmation 609 to the merchant server 602.

Once the merchant server 602 has received confirmation that the payment has been made, the merchant may transfer goods 610 or render services to the user. If the goods are digital goods such as music files, movie files, data, etc., these goods may be transferred directly to the user client 601. Once the transfer of goods or services has been completed, the merchant server 602 may also send a goods transfer confirmation 611 back to the ETF payment system to confirm that the goods or services have been rendered to the user.

### Computing Machine Architecture

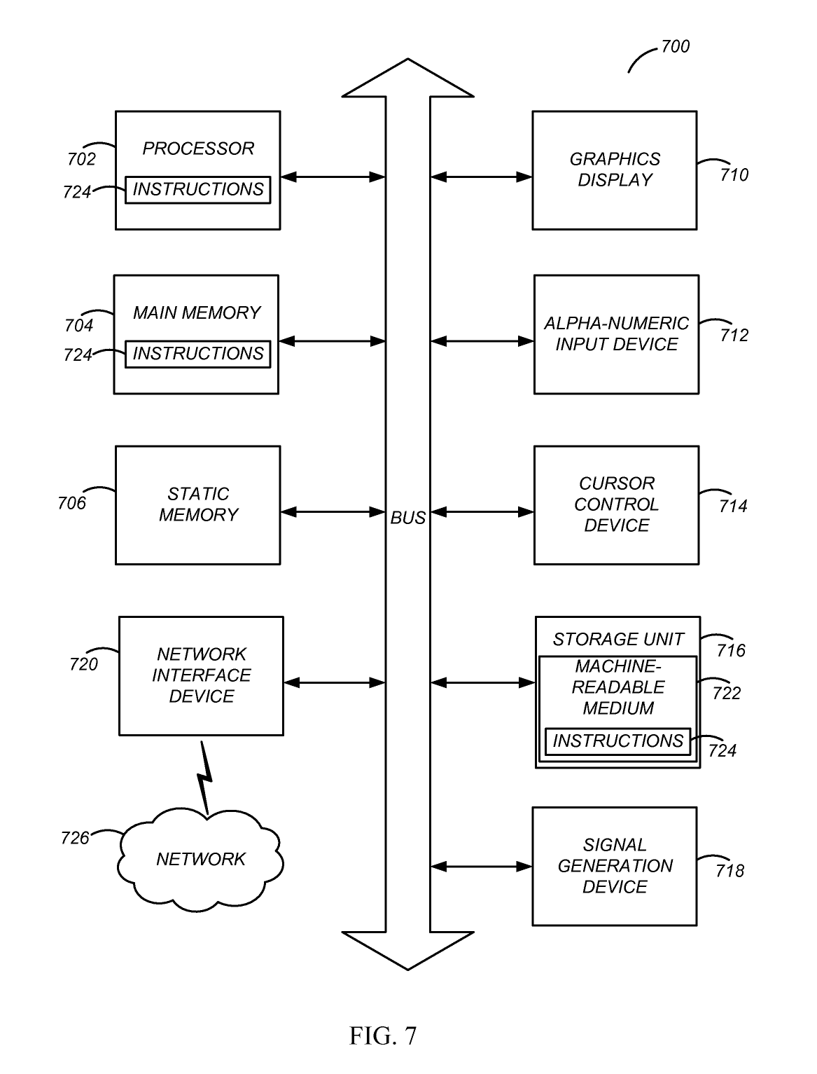

A variety of devices and applications can implement particular examples of a commodity-based ETF payment currency system. FIG. 7 illustrates one example of a computer system. FIG. 7 is a block diagram illustrating components of an example machine able to read instructions from a machine-readable medium and execute them in a processor (or controller). Specifically, FIG. 7 shows a diagrammatic representation of a machine in the example form of a computer system 700 within which instructions 724 (e.g., software) for causing the machine to perform any one or more of the methodologies discussed herein may be executed. In alternative embodiments, the machine operates as a standalone device or may be connected (e.g., networked) to other machines. In a networked deployment, the machine may operate in the capacity of a server machine or a client machine in a server-client network environment, or as a peer machine in a peer-to-peer (or distributed) network environment.

The machine may be a server computer, a client computer, a personal computer (PC), a tablet PC, a set-top box (STB), a personal digital assistant (PDA), a cellular telephone, a smartphone, a web appliance, a network router, switch or bridge, or any machine capable of executing instructions 724 (sequential or otherwise) that specify actions to be taken by that machine. Further, while only a single machine is illustrated, the term “machine” shall also be taken to include any collection of machines that individually or jointly execute instructions 724 to perform any one or more of the methodologies discussed herein.

The example computer system 700 includes a processor 702 (e.g., a central processing unit (CPU), a graphics processing unit (GPU), a digital signal processor (DSP), one or more application specific integrated circuits (ASICs), one or more radio-frequency integrated circuits (RFICs), or any combination of these), a main memory 704, and a static memory 706, which are configured to communicate with each other via a bus 708. The computer system 700 may further include graphics display unit 710 (e.g., a plasma display panel (PDP), a liquid crystal display (LCD), a projector, or a cathode ray tube (CRT)). The computer system 700 may also include alphanumeric input device 712 (e.g., a keyboard), a cursor control device 714 (e.g., a mouse, a trackball, a joystick, a motion sensor, or other pointing instrument), a storage unit 716, a signal generation device 718 (e.g., a speaker), and a network interface device 820, which also are configured to communicate via the bus 708.

The storage unit 716 includes a machine-readable medium 722 on which is stored instructions 724 (e.g., software) embodying any one or more of the methodologies or functions described herein. The instructions 724 (e.g., software) may also reside, completely or at least partially, within the main memory 704 or within the processor 702 (e.g., within a processor's cache memory) during execution thereof by the computer system 700, the main memory 704 and the processor 702 also constituting machine-readable media. The instructions 724 (e.g., software) may be transmitted or received over a network 726 via the network interface device 720.

While machine-readable medium 722 is shown in an example embodiment to be a single medium, the term “machine-readable medium” should be taken to include a single medium or multiple media (e.g., a centralized or distributed database, or associated caches and servers) able to store instructions (e.g., instructions 724). The term “machine-readable medium” shall also be taken to include any medium that is capable of storing instructions (e.g., instructions 724) for execution by the machine and that cause the machine to perform any one or more of the methodologies disclosed herein. The term “machine-readable medium” includes, but not be limited to, data repositories in the form of solid-state memories, optical media, and magnetic media.

### Additional Configuration Considerations

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a process for an electronic payment system using commodity-based exchange traded funds, through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A method, comprising:
receiving a request from a computing device associated with a user to make a payment to a merchant account, the payment comprising a first quantity denominated in a fiat currency;
authenticating the user;
transferring a second quantity of shares of an exchange traded fund (ETF) to the merchant account from a user account, the user account associated with the user, the ETF a commodity-based fund comprising shares of component commodities, the second quantity of shares determined based on the first quantity denominated in the fiat currency;
confirming to a merchant associated with the merchant account that the transfer of the second quantity of shares of the ETF has been made to the merchant account from the user account; and
receiving a notification of a transfer of a non-monetary interest from the merchant to the user.

2. The method of claim 1, wherein determining the second quantity of shares based on the first quantity denominated in the fiat currency, further comprises determining the market price of a share of the ETF.

3. The method of claim 1, further comprising determining if the user account has at least the second quantity of shares in it.

4. The method of claim 1, further comprising receiving a request from a user to purchase a third quantity of shares of the ETF based on a fourth quantity of fiat currency.

5. The method of claim 4, further comprising transferring to the user account the third quantity of shares of the ETF, and purchasing a fifth quantity of shares of component commodities of the ETF, the fifth quantity based on the third quantity, the market price of the component commodities and the inflation rate.

6. An ETF-based electronic payment system comprising:
a computer server configured to receive a request from a computing device associated with a user to make a payment to a merchant account, the payment comprising a first quantity denominated in a fiat currency;
an encryption and authentication system configured to authenticate the user;
a commodity ETF share transfer mechanism configured to transfer a second quantity of shares of the ETF to the merchant account from a user account, the user account associated with the user, the ETF a commodity-based fund comprising shares of component commodities, the second quantity of shares determined based on the first quantity denominated in the fiat currency;
a merchant commodity ETF interface configured to confirm to a merchant associated with the merchant account that the transfer of the second quantity of shares of the ETF has been made to the merchant account from the user account; and
a notification module configured to receive a notification of a transfer of a non-monetary interest from the merchant to the user.

7. The system of claim 6, wherein determining the second quantity of shares based on the first quantity denominated in the fiat currency, further comprises determining the market price of a share of the ETF.

8. The system of claim 6, further comprising, determining if the user account has at least the second quantity of shares in it.

9. The system of claim 6, further comprising, receiving a request from a user to purchase a third quantity of shares of the ETF based on a fourth quantity of fiat currency.

10. The system of claim 9, further comprising, transferring to the user account the third quantity of shares of the ETF, and purchasing a fifth quantity of shares of component commodities of the ETF, the fifth quantity based on the third quantity, the market price of the component commodities and the inflation rate.

11. A computer readable medium configured to store instructions, the instructions when executed by a processor cause the processor to:
receive a request from a computing device associated with a user to make a payment to a merchant account, the payment comprising a first quantity denominated in a fiat currency;
authenticate the user;
transfer a second quantity of shares of an exchange traded fund (ETF) to the merchant account from a user account, the user account associated with the user, the ETF a commodity-based fund comprising shares of component commodities, the second quantity of shares determined based on the first quantity denominated in the fiat currency;
confirm to a merchant associated with the merchant account that the transfer of the second quantity of shares of the ETF has been made to the merchant account from the user account; and
receive a notification of a transfer of a non-monetary interest from the merchant to the user.

12. The computer readable medium of claim 11, wherein the instructions to determine the second quantity of shares based on the first quantity denominated in the fiat currency further comprise instructions that cause the processor to determine the market price of a share of the ETF.

13. The computer readable medium of claim 11, further comprising instructions that cause the processor to determine if the user account has at least the second quantity of shares in it.

14. The computer readable medium of claim 11, further comprising instructions that cause the processor to receive a request from a user to purchase a third quantity of shares of the ETF based on a fourth quantity of fiat currency.

15. The computer readable medium of claim 11, further comprising instructions that cause the processor to transfer to the user account the third quantity of shares of the ETF, and purchase a fifth quantity of shares of component commodities of the ETF, the fifth quantity based on the third quantity, the market price of the component commodities and the inflation rate.
